(19) United States
(12) Patent Application Publication
(10) Pub. No.: US 2005/0115078 A1
(43) Pub. Date: Jun. 2, 2005

(54) Diamond scriber

(75) Inventors: Takayuki Horiuchi, Adachi-ku (JP); Tsuyoshi Numakura, Yuzawa-shi (JP)

Correspondence Address: NIXON PEABODY, LLP, 401 9TH STREET, NW, SUITE 900, WASHINGTON, DC, 20004-2128, US

(73) Assignee: NAMIKI SEIMITSU HOUSEKI KABUSHIKI KAISHA, Tokyo (JP)

(21) Appl. No.: 10/942,094

(22) Filed: Sep. 16, 2004

(30) Foreign Application Priority Data
Sep. 19, 2003 (JP) 2003-327081

(51) Int. Cl. B41C 1/055

(52) U.S. Cl. 30/164.9

(57) ABSTRACT

A diamond scriber is ground at an angle from a tip face toward a ridgeline. Because of this, chipping is less liable to occur, even during high-load scribing of sapphire substrates of 100 μm or greater thickness, or of substrates that have been chemically polished; further, a cutting edge of the diamond scriber has superior resistance to wear out. Accordingly, there can be provided the diamond scriber suited to substrates that must be inscribed at a high load, such as sapphire substrates of 100 μm thickness or more or sapphire substrates chemically polished.

### BACKGROUND OF THE INVENTION

The present invention relates to a diamond scriber, and particularly a diamond scriber characterized by a cutting edge shape.

In the manufacture of semiconductor parts, GaN or other materials are grown on a sapphire substrate, which is then cut to the desired size. A diamond scriber such as that described in, for example, Japanese Patent Laid-Open Publication No. 49-54988 is used when cutting, in order to reduce the generation of chips and provide a cut surface that is clean.

However, because the cutting edge of the diamond scriber is ground to be very sharp, when the substrate is inscribed at a high load, it will wear out very quickly and such phenomena as damage to the cutting edge will occur. For these reasons, the sapphire substrate is ground to less than 100 μm for scribing.

Nevertheless, when the diamond scriber in the above-described publication is used to inscribe a sapphire substrate exceeding 100 μm in thickness, there are problems that it is difficult to obtain a scribe line of a depth that is effective for breaking the substrate. And increasing the scribe load can cause chipping in the scribe line.

Further, when inscribing a substrate surface polished by the chemical polishing process, there are problems that when scribing at a low load the cutting edge of the diamond scriber slides on the polished surface and does not bite for a scribe line. And when inscribing the surface at a high load, it causes chipping in the scribe line.

### SUMMARY OF THE INVENTION

The present invention has been devised in view of the above-described problem points, and an object of the present invention is to provide a diamond scriber that is suited to substrates that must be inscribed at a high load, such as sapphire substrates of 100 μm thickness or more or sapphire substrates chemically polished.

According to the present invention, there is provided a diamond scriber being ground at a specified angle from a tip face toward a ridge line.

Accordingly, there can be provided an effect of reducing chipping in the scribe line of the substrate even when inscribing substrates of 100 μm thickness or more or substrates chemically polished, at a high load. There can be also provided an effect of improving the resistance wearing out the cutting edge of the diamond scriber.

According to a preferred embodiment, the above-described specified angle is in a range from 3° to 30°.

Accordingly, there can be provided an effect of greatly reducing chipping that occurs in the scribe line.

According to another preferred embodiment, the diamond scriber is ground at the specified angle from the tip face toward each ridge line.

### BRIEF DESCRIPTION OF THE DRAWINGS

FIG. 1A is a side view of a diamond scriber, and FIG. 1B is an elevation view of the diamond scriber.

FIGS. 2A and 2B are enlarged views of a diamond particle set in the diamond scriber. FIG. 2A is an enlarged view of the diamond particle from the front; FIG. 2B is an enlarged view of the diamond particle from the side.

FIGS. 3A and 3B are enlarged views of an ordinary diamond particle set in the diamond scriber. FIG. 3A is an enlarged view of the diamond particle from the front; FIG. 3B is an enlarged view of the diamond particle from the side.

### DETAILED DESCRIPTION OF THE INVENTION

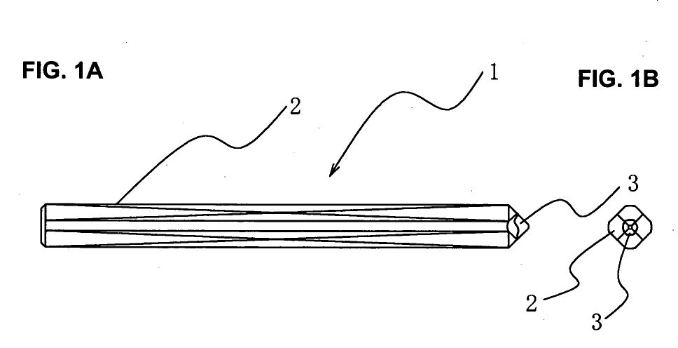

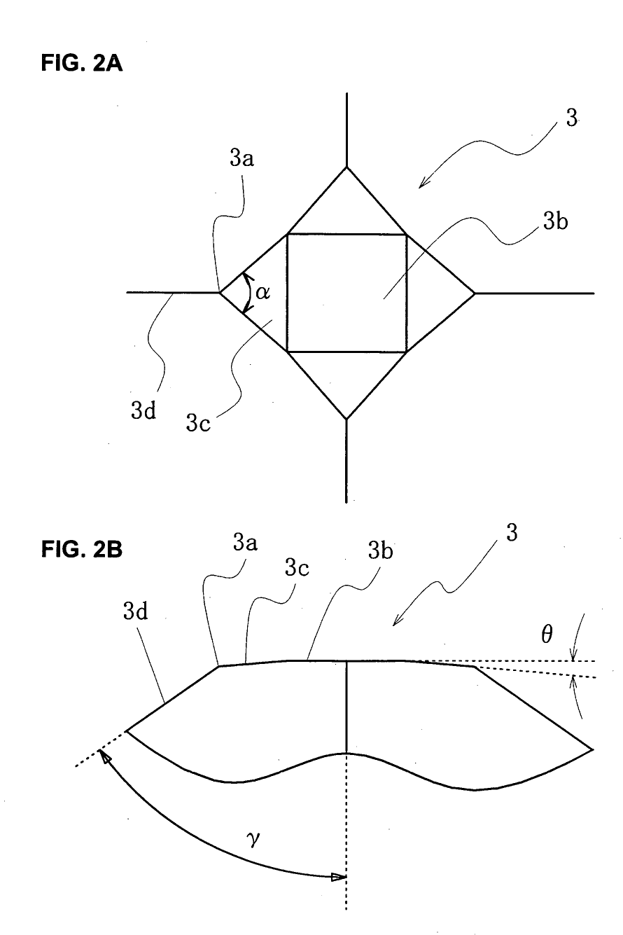

As illustrated in FIGS. 1A and 1B, a diamond scriber 1 is shaped as a square pole. And a diamond particle 3 is fixed in the tip of its shank 2. This diamond particle 3, as illustrated in FIG. 2A, is machined in order to make four cutting edges 3a.

This cutting edge 3a is an apex formed by triangular ground face 3c and a ridgeline 3d; as illustrated in FIG. 2B, it is formed by grinding at a specified angle from a tip face 3b toward the ridgeline 3d. It is preferable that the angle θ formed between the tip face 3b and the ground face 3c is ground in order to become no less than 3° and no more than 30°. If the angle θ is within that range, the resistance from wearing out will be superior to that of an ordinary four-point diamond scriber, and it will be possible to greatly reduce chipping of the substrate.

This mode of implementation is explained using the example of a four-point scriber, but the present invention is not limited to four-point scribers; it can be applied to various scribers with points.

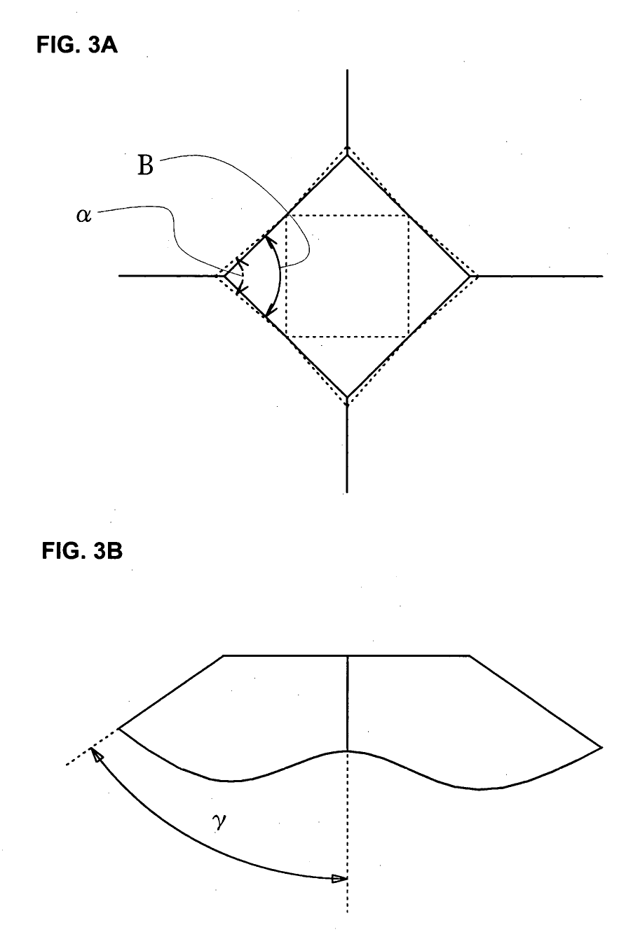

The following explanation deals with a comparison between the scribing of a sapphire wafer of 100 μm thickness using a scriber with the diamond particle illustrated in FIGS. 2A and 2B (the test case) and the scribing of a sapphire wafer of 100 μm thickness using an ordinary scriber with the diamond particle illustrated in FIGS. 3A and 3B (the control case).

[Test Case]
θ: 5°
α: <90°
γ: 55°

Because the diamond scriber of the test case was formed to a 5° angle θ between the tip face 3b and the ground face 3c, worn-out resistance was superior and it was possible to greatly reduce chipping of the wafer. Further, because the angle α of the ground face 3c was no greater than 90°, it was possible to keep the width of the scribe line narrow.

[Control Case]
θ: 0°
β: 90°
γ: 55°

When scribing using the diamond scriber of the control case, chipping of the wafer occurred. Further, the edge wore out faster than that of the diamond scriber of the test case.

As stated above, comparing the diamond scriber of the test case and the diamond scriber of the control case, the diamond scriber of the test case was found to be better suited to substrates that must be inscribed at a high load.

When inscribing sapphire wafers using the diamond scriber of the present invention, it is possible to prevent chipping of the sapphire wafer.

1. A diamond scriber being ground at a specified angle from a tip face toward a ridge line.

2. The diamond scriber as described in claim 1, wherein said specified angle is in a range from 3° to 30°.

3. The diamond scriber as described in claim 1 or 2, being ground at the specified angle from the tip face toward each ridge line.
